(19) United States
(12) Patent Application Publication
(10) Pub. No.: US 2024/0037879 A1
(43) Pub. Date: Feb. 1, 2024

(54) Artificial Reality Integrations with External Devices

(71) Applicant: Meta Platforms Technologies, LLC, Menlo Park, CA (US)

(72) Inventors: Joseph GARDNER, Burlingame, CA (US); Alexander FAABORG, Mountain View, CA (US); Nicholas Ferianc KAMUDA, Seattle, WA (US)

(21) Appl. No.: 18/461,727

(22) Filed: Sep. 6, 2023

Related U.S. Application Data
(60) Provisional application No. 63/578,743, filed on Aug. 25, 2023.
(60) Provisional application No. 63/517,191, filed on Aug. 2, 2023.
(60) Provisional application No. 63/501,512, filed on May 11, 2023.

(51) Int. Cl. G06T 19/00; G06T 13/40; G06V 40/16

(52) U.S. Cl. CPC G06T 19/006; G06T 13/40; G06V 40/174

(57) ABSTRACT

In some implementations, the disclosed systems and methods can be blocked by an obstacle or object, such as wall(s), door(s), or other objects such that a user cannot view the area in a real-world environment. In some implementations, the disclosed systems and methods can interface with smart lights (and/or other smart devices controlling ambient lighting) to know where lights are and how much light they are putting out. In some implementations, the disclosed systems and methods can be animated via user tracking. Some user systems may lack video tracking and/or comprise inconsistent video tracking. In some implementations, the disclosed systems and methods can display content for a screen in a pass-through visualization.

### CROSS REFERENCE TO RELATED APPLICATIONS

This application claims priority to U.S. Provisional Application Nos. 63/501,512 filed May 11, 2023 and titled “Selective Face Tracking for Avatar Animation Using Wearable Sensors,” 63/517,191 filed Aug. 2, 2023 and titled “Pass-Through Visibility System,” and 63/578,743 filed Aug. 25, 2023 and titled “Rendering Control of Virtual Objects Based on Lighting Conditions.” Each patent application listed above is incorporated herein by reference in their entireties.

### BACKGROUND

Head-mounted display (HMD) devices are wearable devices that allow users to immersively view content, such as videos. HMDs can come in various forms, including virtual reality (VR) headsets, mixed reality (MR) glasses, and augmented reality (AR) devices (together XR devices). One of the main advantages of HMDs is their ability to provide a more immersive viewing experience compared to traditional displays, as they can create the illusion of being in a different environment or experiencing a 360-degree view. This is particularly useful for viewing video content filmed in a 360-degree format, such as virtual reality documentaries or immersive gaming experiences. Streaming video to an HMD involves transmitting video data from an image acquisition device to the HMD over a network connection. This can be done in a variety of ways, including through wired connections like HDMI or USB, or wirelessly over a Wi-Fi or cellular network.

Artificial reality (XR) devices are becoming more prevalent. As they become more popular, the applications implemented on such devices are becoming more sophisticated. Augmented reality (AR) applications can provide interactive 3D experiences that combine images of the real-world with virtual objects, while virtual reality (VR) applications can provide an entirely self-contained 3D computer environment. For example, an AR application can be used to superimpose virtual objects over a video feed of a real scene that is observed by a camera. A real-world user in the scene can then make gestures captured by the camera that can provide interactivity between the real-world user and the virtual objects. Mixed reality (MR) systems can allow light to enter a user's eye that is partially generated by a computing system and partially includes light reflected off objects in the real-world. AR, MR, and VR (together XR) experiences can be observed by a user through a head-mounted display (HMD), such as glasses or a headset. An MR HMD can have a pass-through display, which allows light from the real-world to pass through a waveguide that simultaneously emits light from a projector in the MR HMD, allowing the MR HMD to present virtual objects intermixed with real objects the user can actually see.

Artificial reality devices have grown in popularity with users, and this growth is predicted to accelerate. In many artificial reality environments, the user's presence is represented by an avatar. The avatar's movements can be controlled by the user, for example using one or more control devices (e.g., a joystick), based on devices and sensors that sense the user's movements (e.g., cameras, wearable sensors), or a combination of these. Avatar movement can be supported by a variety of different structures and models—such as by matching avatar expressions to language of a corresponding user or identifying an emotional state of the user and causing the avatar to have a corresponding facial expression.

The visual display generated by artificial reality systems involves complex visual data processing, such as when a system displays an immersive environment. Artificial reality systems can display pass-through visualizations, or a display of the user's real-world surroundings as captured by image capturing device(s) associated with the system. Such pass-through displays can include a variety of real-world elements, such as display screens of proximate computing systems. The transient properties of a display screen, which is dynamic in accordance with the screen's refresh rate, can pose challenges when rendering the content of the display screen in a pass-through visualization.

### SUMMARY

Aspects of the present disclosure are directed to a pass-through visibility system that facilitates viewing an area in an artificial reality environment, where the area is generally unviewable from a user's current location. In some examples, the area can be blocked by an obstacle or object, such as a wall(s), door(s), or other objects such that a user cannot view the area in a real-world environment. Upon activation of the pass-through visibility system, one or more image and/or video sources can be selected based on the user's viewing direction. The one or more sources of images and/or video can be from one or more image acquisition devices, such as a camera, capable of capturing the area in the field of view of the acquisition device, where the area can be determined in accordance with the viewing direction of the user. One or more images and/or videos can be provided to a machine learning model whereby the machine learning model can modify and/or generate a video based on the viewing direction or perspective of the user. The generated video can then be integrated into or otherwise rendered into an artificial reality environment as viewed by a user wherein the head-mounted display or artificial reality glasses.

Further aspects of the present disclosure are directed to rendering control of virtual objects in an artificial reality (XR) environment based on lighting conditions. Correctly rendering virtual objects to reflect current ambient lighting in a real-world environment can be challenging. Thus, some implementations can interface with smart lights (and/or other smart devices controlling ambient lighting) to know where lights are and how much light they are putting out. Some implementations can further employ light detection techniques to recognize other physical light sources, such as windows and non-smart lights. Using this data, some implementations can more accurately render lighting on virtual objects. Some implementations can further control smart lights to optimize rendering of the virtual objects.

Yet further aspects of the present disclosure are directed to dynamically animating an avatar with facial expressions using wearable sensor(s). Avatars can be animated via user tracking. Some user systems may lack video tracking and/or comprise inconsistent video tracking. In conventional settings, these systems may animate an avatar using audio data. Implementations include a user system with a wearable device, such as a smartwatch with a camera. At times, depending on the user's positioning, the smartwatch can capture the user's face. During these times, implementations can animate the avatar using the captured user's face instead of the user's audio data. For example, model(s) can detect whether the user's face is captured by the camera(s) of the wearable device. When the user's face is captured, the user's avatar can be animated according to the captured images/video of the user's face. Otherwise, the avatar can be animated according to processed audio data.

Additional aspects of the present disclosure are directed to displaying content for a screen in a pass-through visualization. Artificial reality systems can generate displays using visual data captured by the system, such as a pass-through display of the system's real-world surroundings. In some scenarios, the artificial reality system's captured surroundings include a display screen. A display manager can detect conditions, such as a visual frame that partially captures the screen's displayed content, a captured visual frame that is blank, a visual frame that captures the screen's displayed content in a distorted manner, etc. The display manager can implement mitigation workflow(s) to mitigate the detected conditions, such as: render a previously captured frame, concatenate portions of the visually flawed frame and portions of a previously captured frame, interpolate between two captured frames to generate synthetic visual data that approximates the content of the screen, etc.

### BRIEF DESCRIPTION OF THE DRAWINGS

FIG. 1 is a conceptual diagram illustrating a first viewpoint used in some implementations of the present technology.

FIG. 2 is a conceptual diagram illustrating a floor plan of a house or building and explaining details used in some implementations of the present technology.

FIG. 3 is a conceptual diagram illustrating a second viewpoint used in some implementations of the present technology.

FIG. 4 depicts a conceptual diagram illustrating a machine-learning model of a pass-through visibility system used in some implementations.

FIG. 5 is a flow diagram illustrating a process used in some implementations for acquiring one or more images and generating a video for viewing an area in an artificial reality environment

FIG. 6A is a conceptual diagram of an example real-world environment having various light sources that can be communicated with and/or captured by an artificial reality device.

FIG. 6B is a conceptual diagram of an example view on an artificial reality device of a virtual object, overlaid on a view of a real-world environment, rendered based on light sources in the real-world environment.

FIG. 7 is a flow diagram illustrating a process used in some implementations for controlling rendering of virtual objects based on lighting conditions.

FIG. 8 is a conceptual diagram of animated user avatar expressions.

FIG. 9 is a conceptual diagram of a user with a wearable device.

FIG. 10 is a flow diagram illustrating a process used in some implementations for dynamically animating an avatar with facial expressions using wearable sensor(s).

FIG. 11 is a conceptual diagram illustrating a pass-through visual display for an artificial reality system.

FIG. 12 is a conceptual diagram illustrating techniques for rendering content of a display screen in a pass-through visual display.

FIG. 13 is a system diagram illustrating a technique for receiving and rendering content of a display screen in a pass-through visual display.

FIG. 14 is a flow diagram illustrating a process used in some implementations of the present technology for displaying content for a screen in a pass-through visualization.

FIG. 15 is a block diagram illustrating an overview of devices on which some implementations of the present technology can operate.

FIG. 16 is a block diagram illustrating an overview of an environment in which some implementations of the present technology can operate.

### DESCRIPTION

A pass-through visibility system can facilitate viewing an area in an artificial reality environment, where the area is generally unviewable from a user's current location. In some examples, the area can be blocked by an obstacle or object, such as a wall(s), door(s), or other objects such that a user cannot view the area in a real-world environment. Upon activation of the pass-through visibility system, one or more image and/or video sources can be selected based on the user's viewing direction. The one or more sources of images and/or video can be from one or more image acquisition devices, such as a camera, capable of capturing the area in the field of view of the acquisition device, where the area can be determined in accordance with the viewing direction of the user. One or more images and/or videos can be provided to a machine learning model whereby the machine learning can modify and/or generate a video based on the viewing direction or perspective of the user. The generated video can then be integrated into or otherwise rendered into an artificial reality environment as viewed by a user wherein the head-mounted display or artificial reality glasses.

As previously discussed, a machine learning model can be implemented to receive one or more images or videos associated with a location and modify or generate a video appearing to be from the perspective of a user. A “machine learning model,” as used herein, refers to a construct that is trained using training data to make predictions or provide probabilities for new data items, whether the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of a depth of a pixel in a video frame given based on an analysis of a large number of images from depth cameras. Examples of models include: neural networks, support vector machines, decision trees, Parzen windows, Bayesian, clustering, reinforcement learning, probability distributions, decision tree forests, and others. Models can be configured for various situations, data types, sources, and output formats.

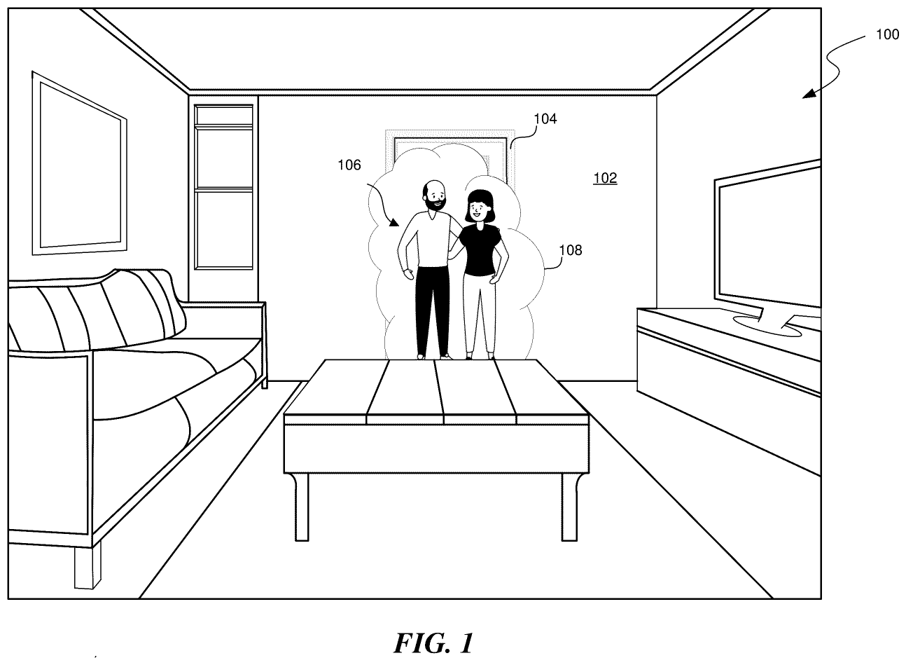

FIG. 1 depicts a conceptual diagram illustrating a first viewpoint 100 used in some implementations of the present technology. Viewpoint 100 can be viewed by a user utilizing an example HMD. In examples, viewpoint 100 can be of room 102, where room 102 includes a door 104 and one or more walls. In a real-world environment, a user would not be able to see through door 104 or the wall of room 102. However, upon activation of the pass-through visibility mode associated with a video pass-through system, an area blocked by one or more obstacles can be rendered into or otherwise added to an artificial reality environment such that the user can effectively view the area blocked by the obstacle. As depicted in FIG. 1, the user can view person 106 in area 108 on the other side of door 104.

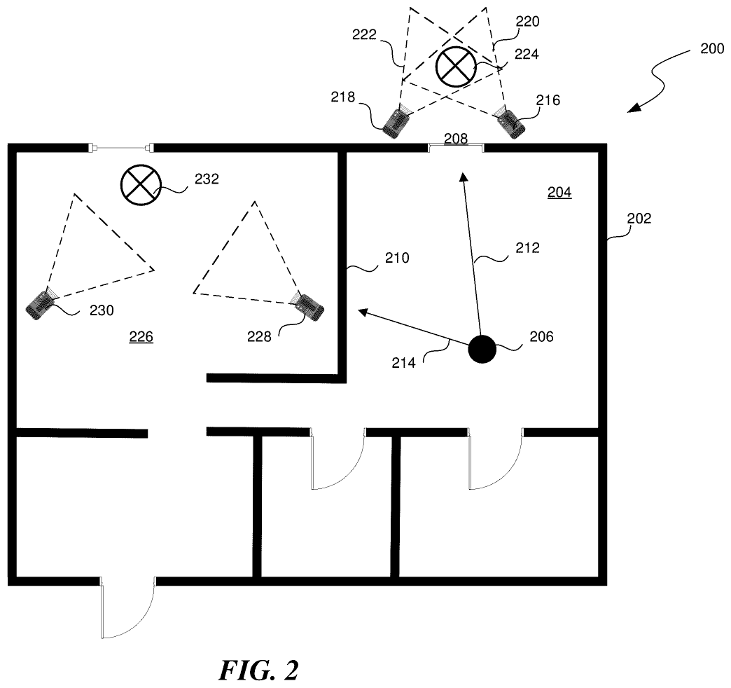

FIG. 2 depicts a conceptual diagram illustrating a floor plan of a house or building 202 used in some implementations of the present technology. In examples, building 202 can include an area or room 204 in which a user can be located. For example, a user can be located at location 206 and may desire to view area 224 on the other side of closed door 208. The user can initiate a pass-through visibility mode to view area 224 on the other side of door 208. In examples, upon initiation of the pass-through visibility mode, the pass-through visibility system can obtain a viewing direction 212 from the HMD of the user. Based on the viewing direction 212 of the user, the pass-through visibility system can identify an obstacle or object blocking a view of the user (e.g., a door, a wall, a tree, etc.) and select one or more image acquisition devices in proximity to the identified obstacle and capable of obtaining an image or video of the area. For example, image acquisition device 216, having a field of view 220, and image acquisition device 218, having a field of view 222, can be selected by the pass-through visibility system as the respective field of views 220 and 222 cover area 224. The pass-through visibility system can then obtain images and/or video from the image acquisition devices and provide the image and/or video to a machine learning model to generate an image and/or video appearing to be from the perspective of the user or otherwise in accordance with the viewing angle 212. The generated image can then be integrated into or otherwise rendered in an artificial reality environment by an HMD for the user's viewing pleasure.

As the user's perspective, or viewing angle, can change, the image and/or video rendered in the artificial reality environment and presented to the user can also change based on the viewing angle. For example, as a user shifts their perspective or views a different location, the pass-through visibility system can determine an object, such as wall 210, blocking or otherwise preventing the user from viewing an area, such as area 226, along a viewing angle 214. Accordingly, the pass-through visibility system can select one or more image acquisition devices 228 and 230, provide the images and/or video acquired from the image acquisition devices 228 and 230 to a machine learning model, and generate an image and/or video in accordance with the viewing angle 224 of the user. In some examples, as a viewing angle transitions, an image acquisition source, such as the image acquisition source 218, can be selected together with an image acquisition device 228, whereby the video from each source can be provided to the machine learning model. One or more images or videos corresponding to the changed viewing angle can be generated and presented to the user as previously discussed.

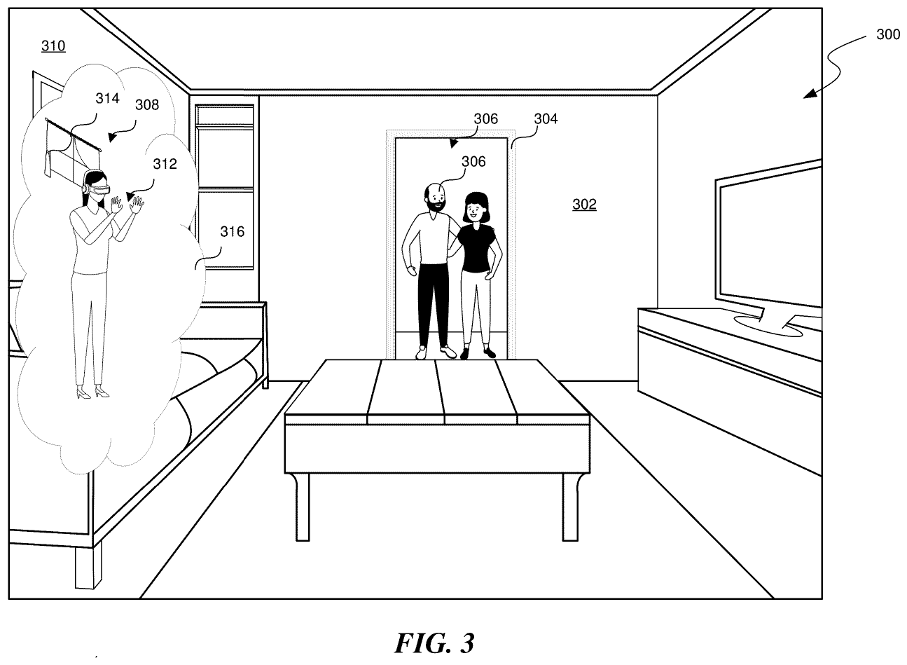

FIG. 3 depicts a conceptual diagram illustrating second viewpoint 300 used in some implementations of the present technology. In examples, room 302 can be the same as or similar to room 202 in FIG. 2, room or area 306 can be the same as or similar to area 224 in FIG. 2, and room or area 308 can be the same as or similar to the room 226 and/or area 232 of FIG. 2. In examples, a user can initiate a pass-through visibility mode to view area 306 behind door 304 and/or to view area 308 behind wall 310. For example, one or more persons 306 can be viewed behind door 304. In some examples, a background associated with an area, such as area 306 can be removed, and segmented objects, people, or things can be presented to the user. Alternatively, or in addition, the background (e.g., object 324) can be obtained and presented to the user as a rendered entity. In some examples, a visual indication 316 can distinguish rendered objects or scenes from objects or areas in the real world.

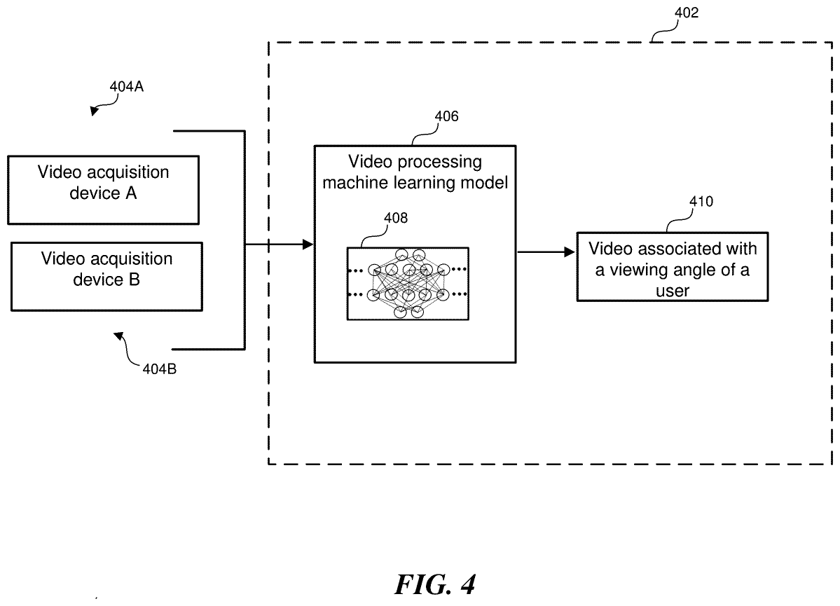

FIG. 4 depicts a conceptual diagram illustrating a machine learning model 406 of a pass-through visibility system 402 used in some implementations. As depicted in FIG. 4, images and/or video from one or more image acquisition devices 404A, 404B can be acquired and provided to the video processing machine learning model 406. In some examples, the user's viewing angle can also be provided to the video processing machine learning model 406. The video processing machine learning model 406 can include a neural network 408, where the video processing machine learning model can be trained on training data comprising one or more images and/or videos, a viewing angle, and processed images and/or video appearing to be from a viewing angle of a user. Accordingly, the video processing machine learning model 406 can generate video 410, which is associated with the user's viewing angle such that when viewed by the user, video 410 appears to be from the user's perspective.

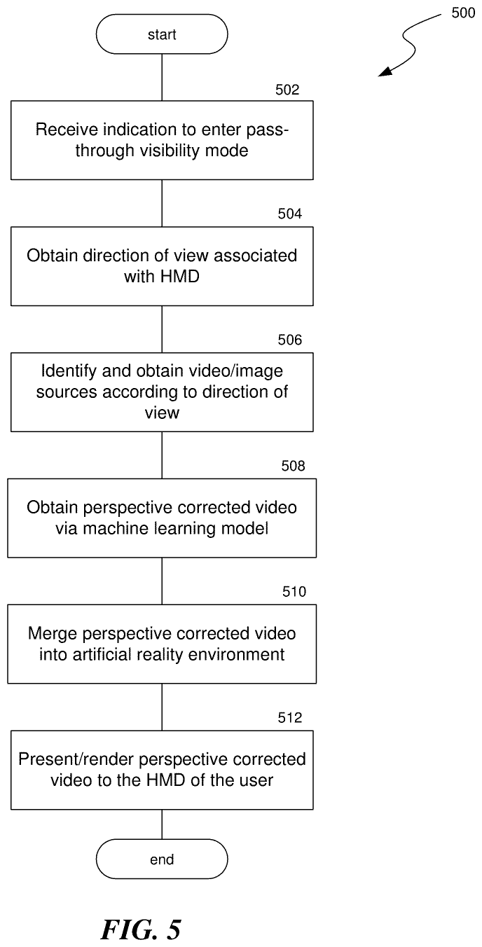

FIG. 5 is a flow diagram illustrating a process 500 for acquiring one or more images and generating a video for viewing an area in an artificial reality environment, where the area is generally unviewable from a user's current location used in some implementations. In some implementations, process 500 can be performed upon an indication to enter a pass-through visibility mode as the user directs. For example, the user can view an obstacle, object, or area for a time greater than a threshold. Alternatively, or in addition, a user can select a prompt, command, or action to initiate the pass-through visibility mode. In some examples, the pass-through visibility mode can be automatically entered when the user is within a specified proximity of an object or obstacle.

At block 502, process 500 can receive an indication to enter the pass-through visibility mode. In some examples, the indication may be specific to the HMD, provided by the user, and/or in response to a user being in proximity to an object.

At block 504, process 500 can obtain a direction associated with the user, such as a viewing direction or viewing angle. For example, the viewing direction or angle can be retrieved from the HMD or otherwise calculated based on information provided by the HMD.

At block 506, the pass-through visibility system can identify one or more sources of images and/or video. The one or more sources of images and/or video can be from one or more image acquisition devices, such as a camera, capable of capturing an area in the field of view of the acquisition device, where the area can be determined in accordance with the viewing direction of the user. In some examples, the sources can be automatically determined based on one or more features acquired in the images and matched to known features. Alternatively, or in addition, one or more sources can be determined based on a pre-established mapping of field of views to areas and the associated acquisition device.

At block 508, one or more images and/or videos can be provided to a machine-learning model with the user's viewing angle and/or location. An image and/or video with the perspective correction or otherwise in accordance with the provided viewing angle or direction can then be obtained. For example, the machine learning model can modify an existing image or video or can generate new images and or video.

At block 510, the image and/or video generated at block 508 can be merged with an artificial reality environment. In some examples, the image and/or video generated at block 508 can be rendered so that the objects behind the obstacle are highlighted or otherwise brought to the user's attention. In some examples, the image and/or video generated at block 508 can be rendered so that the images and/or video provide an immersive environment for the user.

At block 512, the image and/or video generated at block 508 can then be presented to the user via the HMD. For example, the HMD can render or display the merged image and/or video within the artificial reality environment.

Aspects of the present disclosure are directed to controlling rendering of virtual objects in an artificial reality (XR) environment based on ambient lighting in a real-world environment, such as for mixed reality (MR) or augmented reality (AR) experiences. Without consideration of ambient light conditions in such experiences, virtual objects in the XR environment may not visually blend with physical objects in the real-world environment, resulting in a less realistic user experience. Some implementations address these problems and others by interfacing with smart lights (and, in some implementations, other smart devices controlling ambient lighting, such as smart blinds on windows, smart plugs in which standard lights receive power, etc.) to determine their locations, how much light they are emitting, and/or other characteristics of the light (e.g., direction, color, etc.). Some implementations can further identify the locations and/or brightness levels of other physical light sources in the real-world environment, such as non-smart lights, windows, fireplaces, etc. Thus, some implementations can render virtual objects in the XR environment to reflect the current ambient lighting of the real-world environment, e.g., with higher or lower contrast, higher or lower brightness, different coloring, shadowing, etc., based on the current lighting conditions.

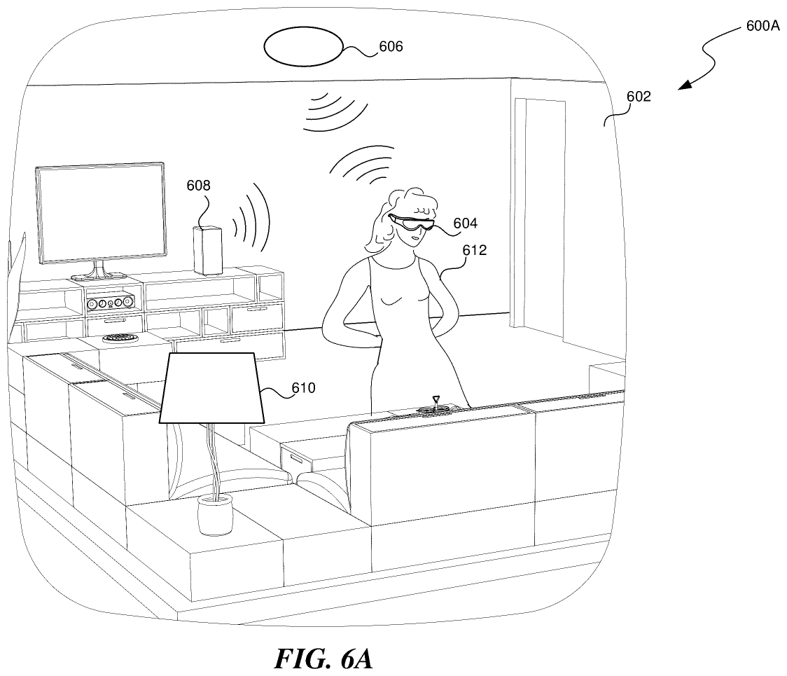

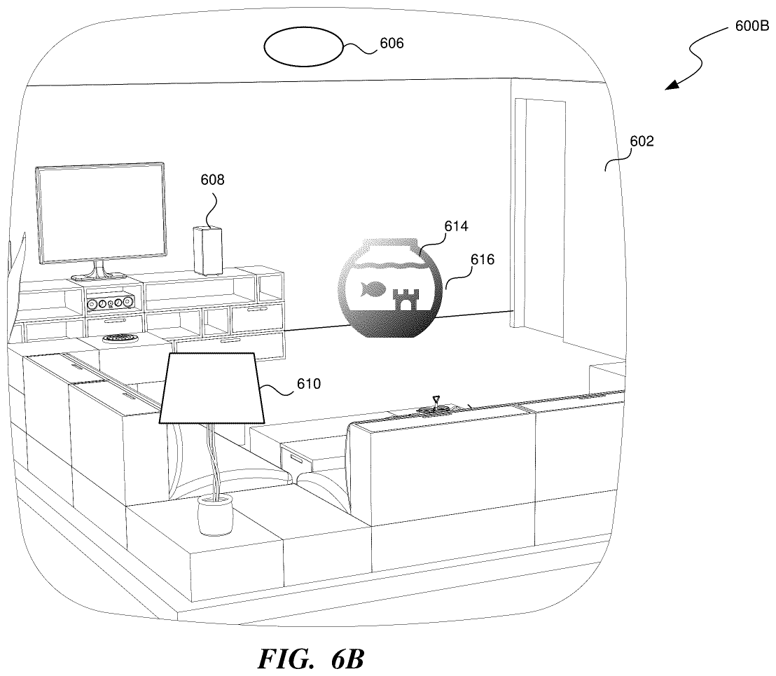

FIG. 6A is a conceptual diagram of an example view 600A of a real-world environment 602 having various light sources that can be communicated with and/or captured by an artificial reality (XR) device 604. In FIG. 6A, XR device 604 can be an XR head-mounted display (HMD) worn by user 612 in real-world environment 602. Real-world environment 602 can include smart light 606, smart hub 608, and non-smart light 610. In some implementations, smart light 606, smart hub 608, and XR device 604 can be in operable communication with each other, such as over a network (e.g., a wireless network, such as WiFi, Bluetooth, etc.). Smart hub 608 can be a networked device controlling and/or managing smart light 606, and, in some implementations, other smart devices (not shown).

Smart light 606 and non-smart light 610 can be exemplary physical light sources, as described further herein. XR device 604 can generate a map of smart light 606 and non-smart light 610 in real-world environment 602, including their respective positions and brightness levels. In some implementations, XR device 604 can obtain the position and brightness of smart light 606 from smart light 606, e.g., by making an application programming interface (API) call to smart light 606 for its position and brightness. In some implementations, XR device 604 can obtain the position and brightness of smart light 606 from smart hub 608, e.g., by making an inquiry to smart hub 608, which can manage and/or control smart light 606.

XR device 604 can obtain the position and brightness of non-smart light 610 by, for example, using simultaneous localization and mapping (SLAM) techniques, in conjunction with one or more sensors. For example, XR device 604 can include one or more optical sensors capturing light emitted from non-smart light 610. Alternatively or additionally, XR device 604 can include one or more cameras capturing images of non-smart light 610, which can be used to identify that non-smart light 610 is a physical light source in real-world environment 602 (e.g., using object recognition techniques), and/or to capture light emitted from non-smart light 610. In some implementations, XR device 604 can use light data captured by the optical sensors and/or the cameras in conjunction with depth data, captured by one or more depth sensors, to determine the position and/or brightness of non-smart light 610.

FIG. 6B is a conceptual diagram of an example view 600B on an artificial reality (XR) device 604 of a virtual object 614, overlaid on a view of a real-world environment 602, rendered based on physical light sources in the real-world environment 602. As in FIG. 6A, the physical light sources can include smart light 606 and non-smart light 610. Upon generating a map of smart light 606 and non-smart light 610 in real-world environment 602, XR device 604 can place virtual light sources, corresponding to smart light 606 and non-smart light 610, in an XR environment that includes virtual object 614. XR device 604 can then render virtual object 614, overlaid onto real-world environment 602, according to the positions and brightness levels of the virtual light sources (corresponding to the physical light sources). In other words, XR device 604 can render virtual object 614 by applying the lighting conditions from the mapped virtual light sources to create virtual light rays affecting the surface texture of virtual object 614. Thus, in example view 600B, XR device 604 can render virtual object 614 with higher light exposure proximate to smart light 606 (which can be a bright light source) relative to non-smart light 610 (which can be a lower brightness light source). XR device 604 can render virtual object 614 with even less light exposure on the portion of virtual object 614 away from smart light 606 and non-smart light 610. Further, XR device 604 can render virtual object 614 with shadow 616 based on the placement and/or brightness of smart light 606 and non-smart light 610.

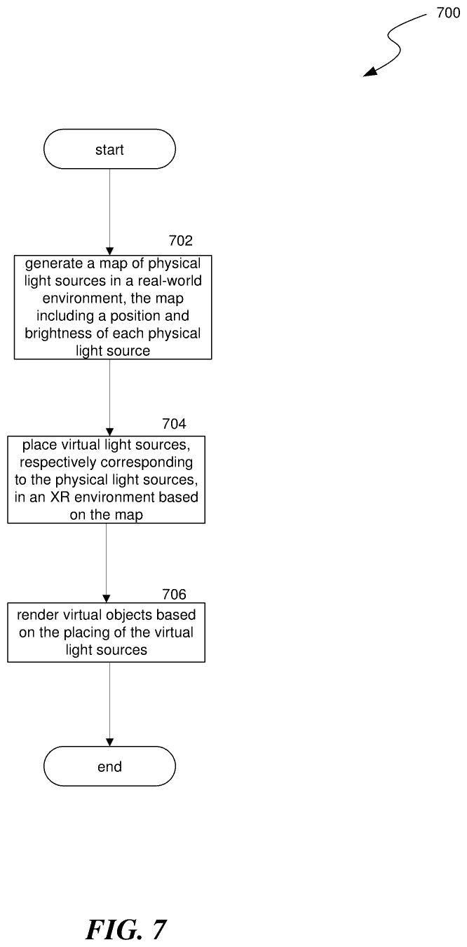

FIG. 7 is a flow diagram illustrating a process 700 used in some implementations for controlling rendering of virtual objects based on lighting conditions. In some implementations, process 700 can be performed as a response to activation or donning of an artificial reality (XR) device. In some implementations, process 700 can be performed as a response to launching of an XR application or experience on an XR device, such as a mixed reality (MR) or augmented reality (AR) experience. In some implementations, process 700 can be performed as a response to a user- or application-generated request to render one or more virtual objects on an XR device, and, in some implementations, in a manner adjusted for lighting conditions. In some implementations, some or all of process 700 can be performed on an XR head-mounted display (HMD). In some implementations, some or all of process 700 can be performed by an XR device other than an XR HMD, such as external processing components.

At block 702, process 700 can generate a map of one or more physical light sources in a real-world environment. The physical light sources can include any natural or artificial source of light in the real-world environment, including, for example, the sun, ceiling lights, desk lamps, floor lamps, electronic devices emitting light (e.g., television screens, computer screens, electronic displays, etc.), mobile devices emitting light (e.g., flashlights, lanterns, etc.), candles, fires (e.g., in fireplaces), and/or the like. In some implementations, the physical light sources can include one or more smart lights. As used herein, a “smart light” can be an Internet (e.g., WiFi) enabled device that can be controllable and/or configurable remotely, such as by an application on an electronic device (e.g., on a mobile phone), and/or automatically based on one or more conditions. For example, a smart light (or group of smart lights) can be controlled and/or managed on demand, based on a schedule, and/or based one or more contextual or environmental factors (e.g., ambient light in a particular room, movement in a particular area, time of day, time of year, status of another smart device, etc.). In some implementations, a smart light can be managed by a smart hub or smart assistant device that can manage, control, and/or otherwise be in communication with the smart light and/or one or more other smart devices (e.g., smart thermostats, smart security systems, smart cameras, smart assistants, etc.) within a physical space (e.g., a home, office, etc.). A smart light can have a number of configurable properties, such as brightness, color, dimming, energy usage, etc.

The map can include, for example, positions and brightness of the physical light sources. In some implementations, such as when the physical light sources include one or more smart lights, the smart lights can provide process 700 with their positions and/or brightness. For example, the smart lights could have previously labeled locations within the real-world environment, such as a particular room (e.g., “living room”), a particular location within a room (e.g., “living room ceiling”), a particular type (e.g., “desk lamp”), and/or other descriptors identifying their locations. In some implementations, process 700 can use previously established spatial anchors, guardian data, and/or scene data to identify the particular locations in the real-world environment where the smart lights are located based on the labels. In some implementations, process 700 can perform object recognition to identify the particular locations in the real-world environment where the smart lights are located based on the labels (e.g., perform object recognition for a desk having a lamp). In some implementations, process 700 can ping the smart lights to transmit wireless signals and/or intercept wireless signals being transmitted from the smart lights, from which process 700 can determine the locations of the smart lights based on where and how process 700 received the transmissions, e.g., a direction, a strength of signal, a type of signal (e.g., Bluetooth Low Energy instead of WiFi), etc. In some implementations, process 700 can combine two or more of these techniques to determine the locations of smart lights.

In some implementations, process 700 can obtain the brightness of the smart lights based on data transmitted by the smart lights (e.g., wattage data, lumen data, type of light (e.g., light-emitted diode (LED)), energy consumption of the light, a percentage of available brightness, etc. In some implementations, process 700 can obtain the brightness of the smart lights based on a detected amount of light emitted in the location of the smart light, as captured by one or more cameras integral with or in operable communication with an XR device. In some implementations, process 700 can combine these techniques to determine the brightness of smart lights.

Process 700 can interface with smart lights in the real-world environment though one or more of a variety of methods. For example, process 700 can obtain data from the smart lights via an application programming interface (API) that the smart lights provide. In another example, process 700 can obtain data from the smart lights via an automated inquiry to a smart hub controlling, managing, and/or otherwise in communication with the smart lights. In still another example, process 700 can retrieve data items indicative of the smart lights' locations and/or brightness levels, written by the smart lights and/or the smart hub, to a local or remote database.

In some implementations, process 700 can determine the locations and brightness levels of other physical light sources that may not be smart lights and/or that cannot (or do not necessarily) provide data indicative of locations and/or brightness to process 700. For example, process 700 can determine the locations of physical light sources in the real-world environment by performing object recognition to identify lamps, windows, fireplaces, etc., which, in some implementations, can be combined with contextual data (e.g., time of day, time of year, temperature, etc.) to determine whether a light source is positioned in a particular location and/or whether the light source is emitting light. In some implementations, process 700 can determine the locations of physical light sources based on where light is being emitted in the real-world environment, as captured by, for example, one or more light sensors and/or cameras integral with or in operable communication with the XR device. In some implementations, process 700 can further determine the positions of physical light sources relative to stored spatial anchors, guardian data, scene data, etc.

In some implementations, process 700 can further obtain the brightness of the physical light sources based on a detected amount of light emitted in the locations of the physical light sources, as captured by one or more light sensors and/or cameras integral with or in operable communication with the XR device. It is contemplated that, in some implementations, process 700 can obtain other characteristics of the emitted light as well, such as direction, color, luminosity, temperature, etc., e.g., using one or more visual sensors. In some implementations, process 700 can determine the locations and/or brightness levels of the physical light sources using a combination of light sensors and/or depth sensors, which, in some implementations, can work in conjunction. In some implementations, process 700 can determine the locations and/or brightness levels of the physical light sources from previously stored data indicative of presence, positions, and/or brightness levels of physical light sources in a physical space, such as those that were previously detected by an XR device. In some implementations, process 700 can determine the locations and/or brightness levels of the physical light sources using one or more of these techniques, and/or one or more of the techniques described above with respect to smart lights when at least one of the physical light sources is network connected.

In some implementations, two or more light sources can be present in the real-world environment, and/or a mixture of smart lights and other physical light sources can be present in the real-world environment. For example, for two physical light sources in a given physical space (e.g., two smart lights identified as being in a living room), process 700 can determine that only one light source is on (i.e., emitting light), such as from data provided by a smart light, from detection (or lack of detection) of two light sources from cameras, etc. Process 700 can then determine the location of the physical light source that is on by, for example, performing simultaneous location and mapping (SLAM) to generate the map including the light source that is emitting light using, e.g., one or more types of sensors, such as optical sensors, cameras, depth sensors, etc.

In some implementations, it is contemplated that process 700 can control the operation of one or more smart lights to determine their positions and/or brightness levels. Alternatively or additionally, in some implementations, it is contemplated that process 700 can control (or be in operable communication with) a smart hub or other device that can control operation of one or more smart lights. For example, when two or more physical light sources (including a smart light) are in a given physical space, process 700 (or the smart hub) can, for example, turn the smart light on or off, change the brightness of the smart light, change the color of the smart light, etc., in order to identify the location of the smart light. Similarly, it is contemplated that a user of the XR device can turn the smart light on or off, change the brightness of the smart light, change the color of the smart light, etc., in order for process 700 to identify the location of the smart light. Although described herein with respect to controlling smart lights, it is contemplated that process 700 can alternatively or additionally control smart plugs from which a standard light is receiving power.

At block 704, process 700 can place one or more virtual light sources, respectively corresponding to the one or more physical light sources, in an XR environment based on the map. In other words, process 700 can place the virtual light sources in the XR environment corresponding to the locations of the physical light sources in the real-world environment, e.g., at coordinates in the XR environment corresponding to coordinates in the real-world environment. Process 700 can further set the virtual light sources to the brightness level (and, in some implementations, other visual characteristics of the light, such as color) corresponding to the brightness of the physical light sources in the real-world environment. In some implementations, process 700 can determine the corresponding positions of the virtual light sources in the XR environment based on the locations of the physical light sources relative to pre-established spatial anchors, guardians, scene data, etc., for the real-world environment. The XR environment can include one or more virtual objects, such as synthetic, artificial visual elements.

At block 706, process 700 can render the one or more virtual objects based on the placing of the one or more virtual light sources in the XR environment. In other words, process 700 can apply the lighting conditions from the virtual light sources to create virtual light rays that affect the surface texture of the virtual objects. In some implementations, the virtual objects can be overlaid on a view of the real-world environment, such as in mixed reality MR or AR. In some implementations, process 700 can render the virtual objects with shadows, brightness, color, texture, etc., based on the positions, brightness, and/or other lighting characteristics of the virtual light sources in the XR environment. For example, for a dark real-world environment having corresponding dark or limited virtual light sources, process 700 can render the virtual objects with less brightness than is needed for a bright real-world environment. Thus, process 700 can give a more realistic and/or optimized user experience in the XR environment via, e.g., improved blending of virtual and physical objects seen on the XR device, conservation of resources on the XR device, etc.

Alternatively or additionally, in some implementations, it is contemplated that process 700 can control the physical light sources to optimize rendering of the virtual objects on the XR device. For example, if the real-world environment is too dim to perform tracking of hands, movements, gestures, etc., of a user in the real-world environment, process 700 can turn on (or cause a smart hub to turn on) one or more smart lights in the real-world environment. In another example, if the real-world environment is too bright and contrast on the XR device is poor, process 700 can turn off (or cause a smart hub to turn off) one or more smart lights in the real-world environment. It is contemplated that process 700 can control physical light sources with other smart devices other than smart lights, however, such as by controlling smart blinds over a window to adjust lighting, controlling smart plugs providing power to non-smart lights, etc. In some implementations, process 700 can instruct a user of the XR device to turn on one or more physical light sources in the real-world environment. In some implementations, process 700 can control (or cause a smart hub to control) smart lights in a real-world environment dynamically based on the virtual objects being rendered and/or characteristics of the virtual objects being rendered, in order to optimize rendering of the XR environment.

Aspects of the present disclosure are directed to dynamically animating an avatar with facial expressions using wearable sensor(s). User avatars (e.g., virtual three-dimensional structures) can be animated via user tracking. Some user systems may lack video tracking and/or comprise inconsistent video tracking. In conventional settings, these systems may animate a user avatar using audio data. For example, the audio data can be transcribed and the audio can be analyzed for emotional states, and the user avatar's face can be animated to appear as if the avatar is speaking the transcribed words while making expressions matching the emotional states. Implementations include a user system with a wearable device, such as a smartwatch with a camera. At times, depending on the user's positioning, the smartwatch can capture the user's face (or portions of the user's face). During these times, implementations can animate the user's avatar using the captured user's face instead of the user's audio data. For example, one or more models can detect whether the user's face is captured by the camera(s) of the wearable device. When the user's face is captured, the user's avatar can be animated according to the captured images/video of the user's face. Otherwise, the user's avatar can be animated according to processed user audio data. In some cases, the data from the smartwatch can be used only when other more reliable user image data is not available, such as from another external capture device.

An avatar manager can either: render the avatar's facial expression using processed user audio data; or render the avatar's facial expression using processed user video data that captures the user's face. For example, one or more models can process the user's audio data to transcribe the text from the data (e.g., words the user has uttered) and/or generate a user sentiment. The one or more models can generate the user sentiment based on the transcribed text (using natural language processing model(s)), and/or based on the user's voice (using one or more models trained to detect human sentiment or emotion from audio voice data). In some implementations, predefined facial expressions (e.g., avatar facial animations) can be mapped to a set of user sentiments. The avatar manager can select a predefined facial expression based on the user sentiment generated by the one or more models. The avatar manager can then render the avatar using the selected predefined facial expression.

In some implementations, the avatar manager can render facial expressions for the user avatar using the captured images/video of the user's face. For example, the avatar manager can determine: whether the user's wrist wearable device is raised; and whether the video captured by the wrist wearable device captures the user's face. When the user's wrist is raised, it can indicate that the wearable device may capture portions of the user's face. Accordingly, when the user's wrist is raised, one or more models (computer vision models) can process the images/video captured by the wearable device cameras to detect whether the user's face is captured. For example, the computer vision models can be trained to detect user faces or portions of user faces.

When the user's wrist is determined to be raised and the images/video from by the wearable device camera(s) capture the user's face, the avatar manager can render the avatar's facial expressions using the captured images/video of the user's face. For example, one or more models can detect the positioning or state of different facial components (e.g., eyes, eyelids, mouth, nose, cheeks, etc.) with respect to the user's face in its entirety. The avatar manager can then use this positioning and/or state data to render the avatar's facial components, thus causing the avatar's rendered face to mimic the user's captured face. Any other suitable technique can be implemented to animate the avatar's face to mimic the user's captured face.

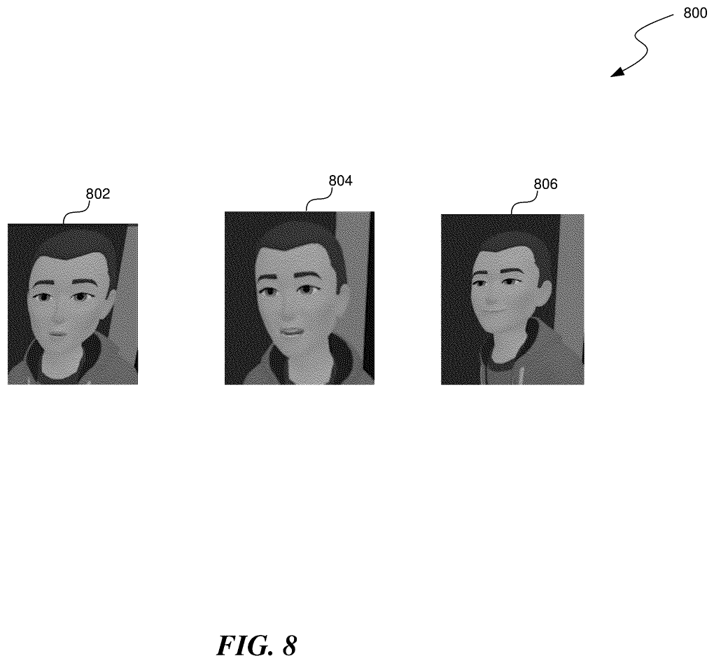

FIG. 8 is a conceptual diagram of animated user avatar expressions. Diagram 800 includes avatar states 802, 804, and 806. An avatar can be a three-dimensional structure (e.g., mesh, skeleton, skin, etc.) that represents a user. The avatar can comprise a head and a human-like body, a portion of a human-like body (e.g., arms and a torso), or any other suitable body. The facial movements and facial expressions of the avatar can be animated according to user tracking.

An avatar manager animates an avatar's facial expressions using captured video of a user's face when such video is available. When such video is not available, the avatar manager animates the avatar's facial expressions using a predefined facial expression, such as a facial expression selected by: processing the user's audio data; outputting a user sentiment; and mapping the user sentiment to one of a plurality of predefined facial expressions. Predefined facial expressions can comprise facial states (e.g., relative position and/or structure information for facial elements, such as eyes, lips, mouth, cheeks, etc.) and/or facial animations (e.g., animations of the facial elements). The predefined facial expressions can be mapped to user sentiments that the facial expressions represent (e.g., a smiling facial expression is mapped to happy, a frowning facial expression is mapped to sad, etc.).

Avatar state 802 can represent an avatar with a neutral facial expression. For example, the sentiment derived from user audio data can comprise a neutral sentiment that maps to a neutral facial expression. Accordingly, the avatar manager can render the avatar with a neutral expression. Avatar state 804 can continue the avatar's neutral expression and animate the avatar's mouth to mimic words uttered by the user (as represented by transcribed user audio). When the avatar manager renders avatar states 802 and 804, captured images/video of the user's face may be unavailable.

In some implementations, between the rendering of avatar state 804 and avatar state 806, user video data may become available. For example, the user's wrist may be raised such that the user's face is captured by camera(s) at the user's wearable device. The avatar manager can then transition from avatar state 804 to avatar state 806. For example, the avatar manager can determine positioning/visual state of the avatar's facial elements such that they correspond to the user's facial elements within the captured images/video of the user's face. The avatar manager can then implement an animated transition from the avatar's facial elements in avatar state 804 to the avatar's facial elements in avatar state 806. The animated transition can be implemented as a linear interpolation (e.g., over 1 to 2 seconds) from the avatar's facial elements in avatar state 804 to the avatar's facial elements in avatar state 806.

As illustrated, when the user's face is captured and used to animate the avatar, the avatar displays a smile (which mimics the user's smile). In this example, when only audio data is processed by model(s), the output sentiment maps to a neutral facial expression rather than a smiling facial expression. Once the captured user video is available, the avatar manager receives sufficient tracked user data to also represent the user's smile via the animated avatar.

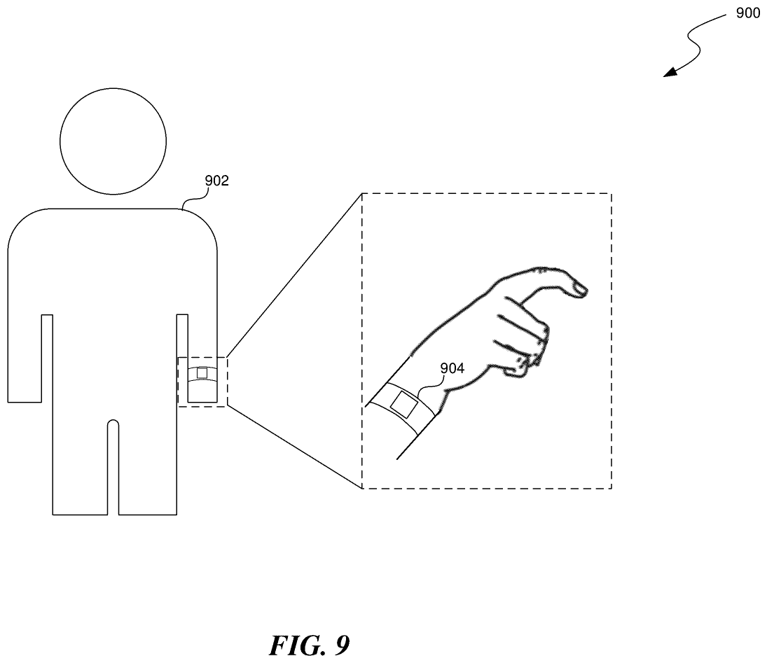

FIG. 9 is a conceptual diagram of a user with a wearable device. Diagram 900 includes user 902 and wearable device 904. User 902 can wear, as part of a computing system (e.g., XR system) a wearable device 904 on the user's wrist, such as a smartwatch. The smartwatch can comprise one or more sensors, such as camera(s). When the user's wrist is raised, the camera(s) of wearable device 904 can, at times, capture the user's face. During these times, the captured images/video of the user's face can be used to animate a user avatar.

In some implementations, the avatar manager determines whether the camera(s) of wearable device 904 capture the user's face via two conditions: is wearable device 904 in a raised position; and does the video captured by wearable device 904 capture the user's face. Additional sensors at wearable device 904 (e.g., accelerometer, inertial measurement unit (IMU), etc.) can detect positional signals that can be processed to determine the state, such as whether the wearable device is in a raised position or not. Any suitable model(s) can process this signal data to determine the state of wearable device 904.

When wearable device 904 is raised, one or more models (e.g., computer vision models) can process the images/video captured by wearable device 904 to determine whether the user's face is captured. For example, computer vision models can be trained with training data of images of user faces (or portions of user faces) such that the models can output a predicted likelihood that captured images/video comprise a user face or a portion of a user face.

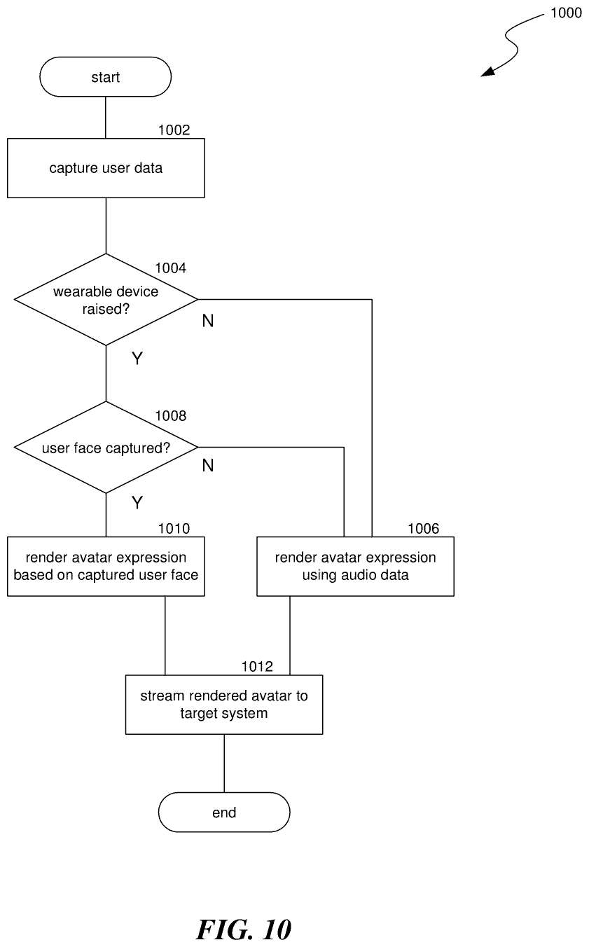

FIG. 10 is a flow diagram illustrating a process used in some implementations for dynamically animating an avatar with facial expressions using wearable sensor(s). In some implementations, process 1000 can be triggered when an XR application is launched, a user avatar is rendered, or via any other suitable software functionality. Process 1000 can be implemented at an XR system or any other system that can render a user avatar using tracked user data.

At block 1002, process 1000 can capture user data. For example, the captured user data can include user audio data (e.g., the voice of the user uttering words). In some implementations, the captured user data can comprise user video data, such as images/video captured via a wearable device at the user's wrist (e.g., a smartwatch).

At block 1004, process 1000 can determine whether the user's wearable device is raised. For example, sensor signals (e.g., IMU signals) from the user's wearable device can be processed to determine a state of the user's wearable device (e.g., raised or not raised). When the user's wearable device is raised, process 1000 can progress to block 1008. When the user's wearable device is not raised, process 1000 can progress to block 1006.

At block 1006, process 1000 can render avatar facial expression(s) using user audio data. For example, the user audio data can be processed by one or more models to output transcribed user text and/or a user sentiment. The user sentiment can be mapped to a predefined facial expression. The avatar's face can be rendered according to the transcribed text (e.g., such that the avatar will appear to speak the text) and the mapped predefined facial expression.

At block 1008, process 1000 can determine whether the user's face is captured by camera(s) at the user's wearable device. For example, one or more models (e.g., computer vision models) can process video captured by camera(s) at the wearable device to detect whether the user's face is captured. The model(s) can be trained to detect user faces and/or portions of user faces. When the user's face is detected in the captured images/video, process 1000 can progress to block 1008. When the user's face is not detected in the captured images/video, process 1000 can progress to block 1006, where the avatar facial expressions can be rendered using the user audio data.

At block 1010, process 1000 can render avatar expression(s) based on the captured user's face. For example, one or more computer vision models can process the captured images/video of the user's face to detect the positioning or state of different facial components (e.g., eyes, eyelids, mouth, nose, cheeks, etc.) with respect to the user's face. This positioning and/or state data can be used to render the avatar's facial components, thus causing the avatar's rendered face to mimic the user's captured face. Any other suitable technique can be implemented to animate the avatar's face to mimic the user's captured face.

At block 1012, process 1000 can stream the rendered avatar to a target system. For example, the rendered avatar can be streamed to a target user system, which displays the avatar to other user(s). In some implementations, the displayed avatar can be part of a virtual call, virtual meeting, shared XR environment, and the like.

Aspects of the present disclosure are directed to displaying content for a screen in a pass-through visualization. Artificial reality systems can generate displays using visual data captured by the system and/or captured by connected image capturing devices. An example of such a technique is a pass-through display, where an artificial reality system generates a display of the system's real-world surroundings (or an augmented version of the real-world surroundings). Such pass-through displays can include a variety of real-world elements, such as display screens of proximate computing systems. Unlike conventional real-world elements, a screen displays content according to the screen's refresh or display rate, which can cause challenges when rendering a pass-through display. For example, mismatches among the screen's display rate, the capture rate of the image capturing device(s), and/or the display rate of the artificial reality system's display(s), or lack of synchronization between refresh cycles, can create visual flaws, such as blank frames, partial frames, or other suitable flaws related to the visual capture of the screen's displayed content. Implementations of a display manager can detect conditions that may cause such visual flaws in a pass-through visualization and implement mitigation workflow(s) to mitigate and/or eliminate the visual flaws when rendering the pass-through display.

The display manager can detect conditions such as a visual frame that partially captures the screen's displayed content, a captured visual frame that is blank (or mostly blank), a visual frame that captures the screen's displayed content in a distorted manner, or any other suitable visual flaw in the captured visual frame(s) of the content displayed by the screen. The display manager can implement mitigation workflow(s) to mitigate and/or remedy the detected conditions, such as: render a previously captured frame, stitch (e.g., concatenate) portions of the visually flawed frame and portions of a previously captured frame, interpolate between two captured frames to generate synthetic visual data that approximates the content of the screen, or any combination thereof. In some implementations, the display manager can detect a connection (or a potential connection) with a source system that renders or otherwise provides the content for display at the captured screen, trigger/request a stream of the content to the artificial reality system from the source system, and render a virtual screen within the boundaries of the captured screen using the streamed content.

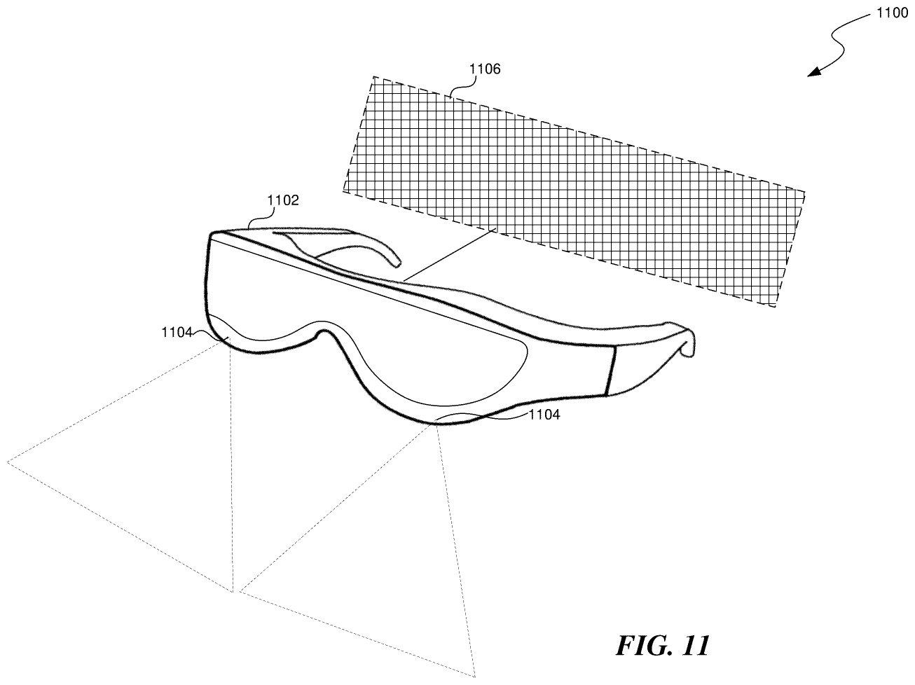

FIG. 11 is a conceptual diagram illustrating a pass-through visual display for an artificial reality (XR) system. Diagram 1100 illustrates XR system 1102, image capturing devices 1104, and pass-through display 1106. Image capturing devices 1104 can capture the real-world surroundings of XR system 1102. XR system 1102 can process the captured visual data and generate pass-through display 1106. For example, pass-through display 506 can comprise an XR environment from the user's perspective of the user's real-world environment.

In some implementations, pass-through display 1106 can comprise a display screen of a computing system. For example, the real-world surroundings captured by XR system 1102 can include a display screen, such as a laptop screen, desktop screen, smartphone screen, television screen, smart home device screen, or any other suitable screen associated with a computing system. In such scenarios, conventional rendering of the pass-through visual data may cause visual flaws with respect to the display screen's content. For example, the screen's display of content according to its display rate may be misaligned and/or out of synchronization with one or more of the capture rate of image capturing devices 1104 and/or the display rate of XR system 1102's display(s). Such misalignment or lack of synchronization can cause captured frames to be blank, partial, distorted, etc. Implementations perform mitigation workflow(s) to render content for a display screen that mitigates such visual flaws.

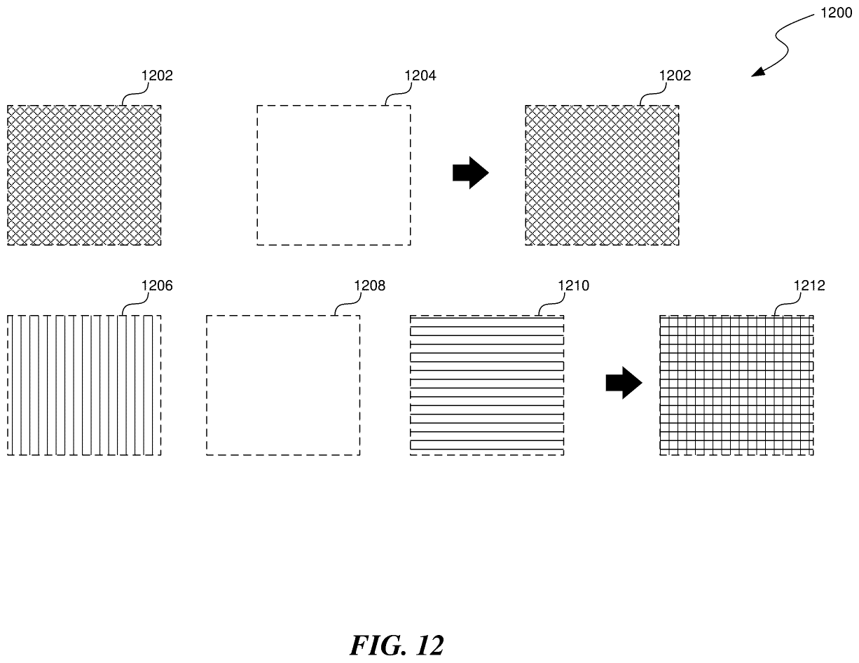

FIG. 12 is a conceptual diagram illustrating techniques for rendering content of a display screen in a pass-through visual display. Diagram 1200 illustrates captured frames 1202, 1204, 1206, 1208, and 1210, and processed frame 1212. Captured frames 1202 and 1204 can represent two visual frames that capture the content of a screen in succession. Captured frame 1202 can be a complete (or nearly complete) frame that comprises visual data representative of the content of the screen. Captured frame 1204 can be a blank (or nearly blank) frame that comprises visual data that is not representative of the content of the screen. When such a condition is detected, a first example mitigation workflow is to render visual data from captured frame 1202 in place of captured frame 1204. In this example, a frame previously captured is utilized to mitigate against rendering a blank (or mostly blank) screen in the pass-through visualization.

In some implementations, captured frame 1204 can be a partial frame that comprises visual data that is representative of a portion of the content of the screen. When such a condition is detected, a second example mitigation workflow is to concatenate captured frame 1202 with captured frame 1204 and render visual data from this concatenated frame in place of captured frame 1204. For example, implementations can detect which portion(s) of the content of the screen are missing from captured frame 1204, select portion(s) of captured frame 1202 that correspond to these missing portion(s) from captured frame 1204, and concatenate the visual data to fill the gap(s) of captured frame 1204. In this example, a frame previously captured is utilized to mitigate against rendering only portions of the content of the screen in the pass-through visualization.

Captured frames 1206, 1208, and 1210 can represent three visual frames that capture the content of a screen in succession. Captured frame 1206 can be a complete (or nearly complete) frame that comprises visual data representative of the content of the screen. Captured frame 1208 can be a blank, partially blank, or distorted frame that comprises visual data that is not representative of the content of the screen. Captured frame 1210 can be a complete (or nearly complete) frame that comprises visual data representative of the content of the screen. Together, captured frames 1206, 1208, and 1210 illustrate an example where two frames capture sufficient visual data representative of the content of the screen while the frame between these two frames comprises flawed visual data.

When such a condition is detected, a third example mitigation workflow is to process the visual data of captured frames 1206 and 1210 to interpolate synthetic visual data representative of the content of the screen at the time captured frame 1208 is captured. In other words, the synthetic visual data can approximate a version of captured frame 1208 that does not comprise flawed visual data. Visual data from processed frame 1212, which represents visual data generated via interpolation of captured frames 1206 and 1210, can be rendered in place of the visual data frame captured frame 1208. In this example, frames captured before and after a target frame are utilized to mitigate against rendering a blank, distorted, or partially filled screen in the pass-through visualization.

Performing the interpolation between captured frames 1206 and 1210 to generate the synthetic visual data can accomplished via any suitable technique. For example, the pixel data values of captured frames 1206 and 1210 can be used to perform the interpolation. In some implementations, a machine learning model trained to generate such synthetic visual data can be fed captured frames 1206 and 1210 as input and can output the synthetic visual data. Any other suitable techniques can be used to perform the interpolation.

In some implementations, the mitigation workflow performed can be selected based on the content displayed by the screen. For example, a first mitigation workflow can be selected when the content is gaming content and a second mitigation workflow can be selected when the content is productivity content (e.g., application content related to productivity, such as data tables, spreadsheets, documents, and the like). In this example, a mitigation workflow can be selected that corresponds to the nature of the content and how often the content changes. Because some mitigation workflows may utilize previously captured frames, some workflows may work better for relatively fast moving content and other workflows may work better for relatively slow moving content.

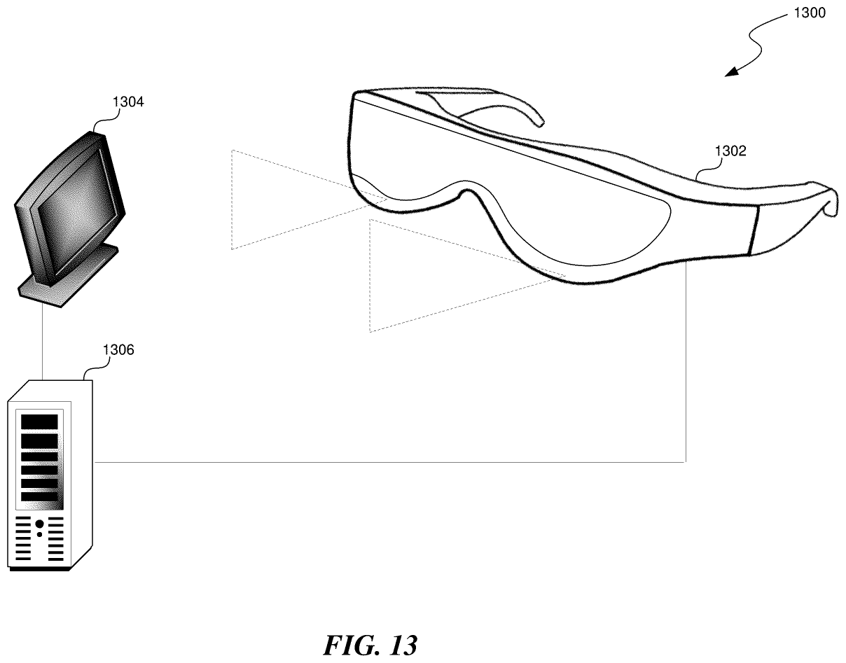

In some implementations, mitigating against flaws in a pass-through visualization that includes a captured screen can include triggering a communication channel to directly receive the content displayed on the screen. FIG. 13 is a system diagram illustrating a technique for receiving and rendering content of a display screen in a pass-through visual display. Diagram 1300 includes XR system 1302, display screen 1304, and system 1306.

In some implementations, XR system 1302 can capture display screen 1304 via camera(s). Once XR system 1302 detects that the captured visual data includes content of display screen 1304, display screen 1304 and/or the captured content can be analyzed to determine whether XR system 1302 comprises a connection with display screen 1304's content source or comprises a potential connection (e.g., approved connection, connection in response to a request, etc.) with this content source. In the illustrated example, system 1306 can be the content source for display screen 1304. The combination of display screen 1304 and system 1306 can be any suitable system with a display screen, such as a smartphone, television, laptop, desktop, smart home device, or any other suitable system.

In some implementations, XR system 1302 can detect that system 1306 comprises a computing system from which the XR system can receive content over an existing or triggered communication channel (e.g., previously configured desktop, television, laptop, smartphone, etc.). In some implementations, XR system 1302 can detect that the content displayed via display screen 1304 is from an application loaded at XR system 1302. In this example, the identified application can be used to trigger and/or select the connection between XR system 1302 and system 1306.

XR system 1302 can identify an existing connection (e.g., wireless connection) with system 1306 or trigger a connection with system 1306. The content displayed by display screen 1304 can be streamed from system 1306 to XR system 1302 over this connection. For example, display screen 1304 can be the display panel of a desktop or television, and system 1306 can stream the same content displayed on the display panel to XR system 1302. XR system 1302 can receive the streamed content, process the content, and render a virtual display within the boundaries of display screen 1304 using the processed content. For example, the virtual display can comprise an augment displayed within a pass-through visualization of the real-world surroundings of XR system 1302. In some implementations, processing the content can include scaling and/or altering the perspective of the content according to the user's perspective with respect to display screen 1304.

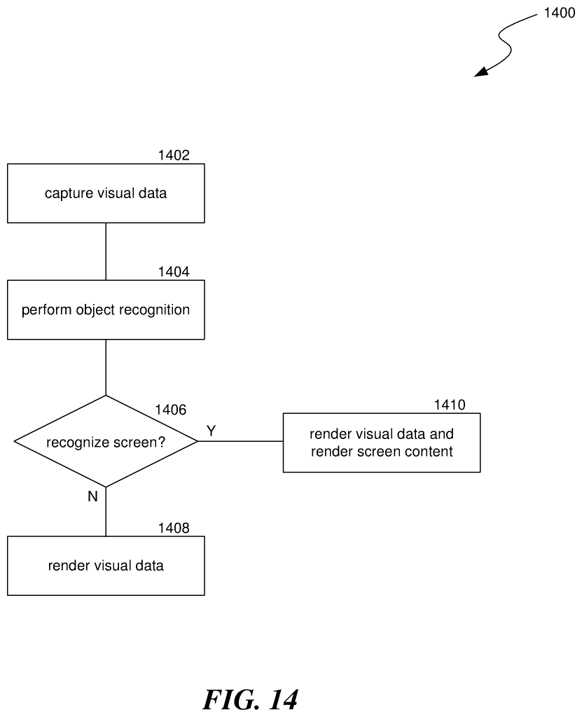

FIG. 14 is a flow diagram illustrating a process used in some implementations of the present technology for displaying content for a screen in a pass-through visualization. In some implementations, process 1400 is performed by an XR system. Process 1400 can be triggered by initiating the display of or continuing the display of an XR environment to a user.

At block 1402, process 1400 can capture visual data via image capturing device(s). For example, the XR system can include and/or communicate with camera(s) that capture the real-world surroundings of the user/XR system. In some implementations, the XR system can generate a pass-through display of the real-world surroundings using the captured visual data.

At block 1404, process 1400 can perform object recognition. For example, the captured visual data can be processed via one or more object recognition models, such as computer vision models, other machine learning models, or any other suitable models. The model(s) can detect screens based on a known shape of screen(s) and/or a known shape of devices comprising screens (e.g., smartphone, laptop, tablet, computer monitor, etc.), brand logos associated with screens, the inconsistent capture of content displayed within a shape affiliated with a screen, or any other suitable technique.

At block 1406, process 1400 can determine whether a display screen is recognized in the captured visual data. Based on the performed object recognition, a display screen may be detected in the captured visual data. When a display screen is not recognized, process 1400 can progress to block 1408. When a display screen is recognized, process 1400 can progress to block 1410.

At block 1408, process 1400 can render the visual data for the pass-through display. For example, one or more render passes can be performed, such as using hardware resources (e.g., processors, such as GPU(s) and/or CPU(s), etc.), to render the pass-through visual data of the XR system's real-world surroundings. The pass-through visual data can be displayed to the user.

At block 1410, process 1400 can render the visual data for the pass-through display and separately render screen content for the recognized display screen. For example, one or more render passes can be performed, such as using hardware resources, to render the pass-through visual data of the XR system's real-world surroundings and to separately render the content of the detected screen.

In some implementations, the capturing is iterated over a cycle according to a capture rate, and the pass-through display is rendered using visual data captured over the cycle iterations. Content can be rendered within the detected screen by performing at least one of: a) rendering visual data captured in a previous iteration of the cycle in response to detecting that the visual data captured in a current iteration of the cycle comprises a threshold amount of blank or distorted visual data; b) combining visual data captured over multiple iterations of the cycle by concatenating portions of the multiple frames or interpolating visual data using the multiple visual frames; or c) rendering a virtual screen within the detected screen using content streamed to the XR system by a computing system associated with the detected screen.

For example, rendering visual data captured in a previous iteration of the cycle can include rendering a visual frame captured in a previous iteration of the camera capture cycle in place of the visual frame captured in the current iteration of the camera capture cycle. In another example, visual data captured over multiple iterations of the cycle can be combined by concatenating portions of the multiple frames. Process 1400 can detect which portion(s) of a visual frame captured in a current cycle iteration are blank or distorted, select portion(s) of a visual frame captured in a previous cycle iteration that correspond to these missing portion(s), and concatenate the visual data to fill the gap(s) of the visual frame captured in the current cycle iteration.

In another example, visual data captured over multiple iterations of the cycle can be combined by interpolating visual data over multiple visual frames. E.g., three visual frames can capture the content of a screen in successive iterations of the capture cycle. A first captured frame can be a complete (or nearly complete) frame that comprises visual data representative of the content of the screen, a second captured frame can be a blank, partially blank, or distorted frame that comprises visual data that is not representative of the content of the screen, and a third captured frame can be a complete (or nearly complete) frame that comprises visual data representative of the content of the screen. Together, the three captured frames illustrate an example where two frames capture sufficient visual data representative of the content of the screen while the frame between these two frames comprises flawed visual data. When process 1400 detects such a condition, visual data from the first and third visual frames can be used to interpolate synthetic visual data representative of the content of the screen at the time the second visual frame is captured. In other words, the synthetic visual data can approximate a version of the second captured visual frame that does not comprise flawed visual data.

In another example, rendering a virtual screen within the detected screen can be achieved by using content streamed to the XR system by a computing system associated with the detected screen. Process 1400 can detect that the captured visual data includes content from a screen (e.g., via block 1406), and analyze the captured content/display screen to determine whether a connection (or potential connection) with the display screen's content source is available. For example, process 1400 can detect that the content source is a computing system from which the XR system can receive content over an existing or triggered communication channel (e.g., a known desktop, television, laptop, smartphone, etc. with which the XR system is configured to communicate).

In some implementations, process 1400 can detect that the content is from an application loaded at the XR system. In this example, the identified application can be used to trigger and/or select the connection between the XR system and the content source. Process 1400 can also identify an existing connection (e.g., wireless connection) with the content source or trigger a connection in any other suitable manner. The content displayed by the detected screen can be streamed from the content source to the XR system over this existing or established connection. The XR system can receive the streamed content, process the content, and render a virtual display within the boundaries of the detected display screen using the processed content. For example, the virtual display can comprise an augment displayed within a pass-through visualization of the real-world surroundings of the XR system.

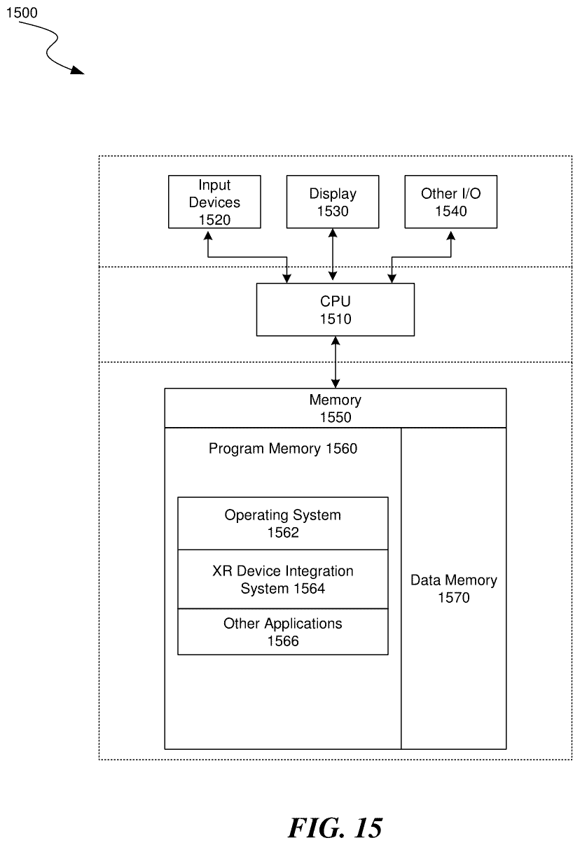

FIG. 15 is a block diagram illustrating an overview of devices on which some implementations of the disclosed technology can operate. The devices can comprise hardware components of a device 1500 as shown and described herein. Device 1500 can include one or more input devices 1520 that provide input to the Processor(s) 1510 (e.g., CPU(s), GPU(s), HPU(s), etc.), notifying it of actions. The actions can be mediated by a hardware controller that interprets the signals received from the input device and communicates the information to the processors 1510 using a communication protocol. Input devices 1520 include, for example, a mouse, a keyboard, a touchscreen, an infrared sensor, a touchpad, a wearable input device, a camera- or image-based input device, a microphone, or other user input devices.

Processors 1510 can be a single processing unit or multiple processing units in a device or distributed across multiple devices. Processors 1510 can be coupled to other hardware devices, for example, with the use of a bus, such as a PCI bus or SCSI bus. The processors 1510 can communicate with a hardware controller for devices, such as for a display 1530. Display 1530 can be used to display text and graphics. In some implementations, display 1530 provides graphical and textual visual feedback to a user. In some implementations, display 1530 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 1540 can also be coupled to the processor, such as a network card, video card, audio card, USB, firewire or other external device, camera, printer, speakers, CD-ROM drive, DVD drive, disk drive, or Blu-Ray device.

In some implementations, the device 1500 also includes a communication device capable of communicating wirelessly or wire-based with a network node. The communication device can communicate with another device or a server through a network using, for example, TCP/IP protocols. Device 1500 can utilize the communication device to distribute operations across multiple network devices.

The processors 1510 can have access to a memory 1550 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 1550 can include program memory 1560 that stores programs and software, such as an operating system 1562, XR device integration system 1564, and other application programs 1566. Memory 1550 can also include data memory 1570, which can be provided to the program memory 1560 or any element of the device 1500.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

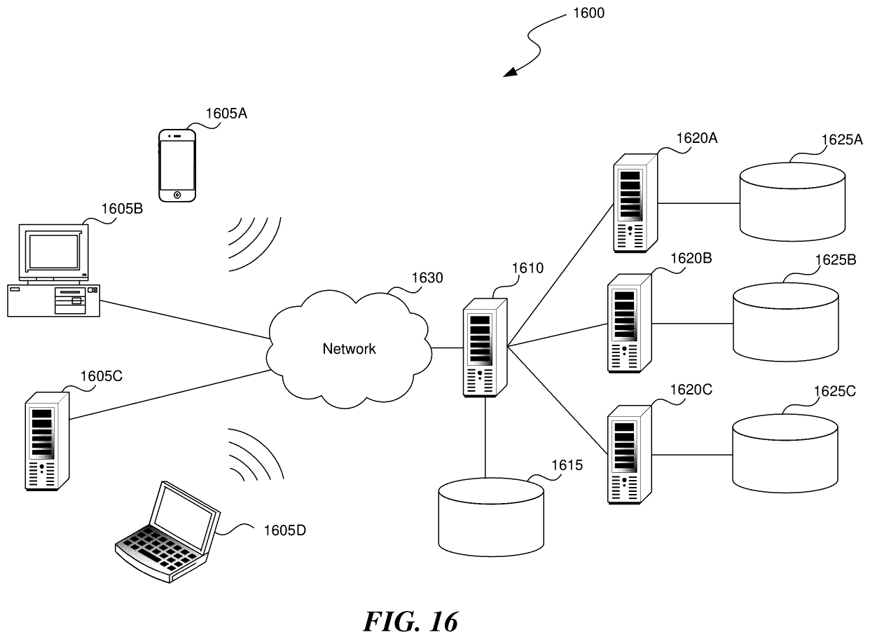

FIG. 16 is a block diagram illustrating an overview of an environment 1600 in which some implementations of the disclosed technology can operate. Environment 1600 can include one or more client computing devices 1605A-D, examples of which can include device 1500. Client computing devices 1605 can operate in a networked environment using logical connections through network 1630 to one or more remote computers, such as a server computing device.

In some implementations, server 1610 can be an edge server which receives client requests and coordinates fulfillment of those requests through other servers, such as servers 1620A-C. Server computing devices 1610 and 1620 can comprise computing systems, such as device 1500. Though each server computing device 1610 and 1620 is displayed logically as a single server, server computing devices can each be a distributed computing environment encompassing multiple computing devices located at the same or at geographically disparate physical locations. In some implementations, each server 1620 corresponds to a group of servers.

Client computing devices 1605 and server computing devices 1610 and 1620 can each act as a server or client to other server/client devices. Server 1610 can connect to a database 1615. Servers 1620A-C can each connect to a corresponding database 1625A-C. As discussed above, each server 1620 can correspond to a group of servers, and each of these servers can share a database or can have their own database. Databases 1615 and 1625 can warehouse (e.g., store) information. Though databases 1615 and 1625 are displayed logically as single units, databases 1615 and 1625 can each be a distributed computing environment encompassing multiple computing devices, can be located within their corresponding server, or can be located at the same or at geographically disparate physical locations.

Network 1630 can be a local area network (LAN) or a wide area network (WAN), but can also be other wired or wireless networks. Network 1630 may be the Internet or some other public or private network. Client computing devices 1605 can be connected to network 1630 through a network interface, such as by wired or wireless communication. While the connections between server 1610 and servers 1620 are shown as separate connections, these connections can be any kind of local, wide area, wired, or wireless network, including network 1630 or a separate public or private network.

In some implementations, servers 1610 and 1620 can be used as part of a social network. The social network can maintain a social graph and perform various actions based on the social graph. A social graph can include a set of nodes (representing social networking system objects, also known as social objects) interconnected by edges (representing interactions, activity, or relatedness). A social networking system object can be a social networking system user, nonperson entity, content item, group, social networking system page, location, application, subject, concept representation or other social networking system object, e.g., a movie, a band, a book, etc. Content items can be any digital data such as text, images, audio, video, links, webpages, minutia (e.g., indicia provided from a client device such as emotion indicators, status text snippets, location indictors, etc.), or other multi-media. In various implementations, content items can be social network items or parts of social network items, such as posts, likes, mentions, news items, events, shares, comments, messages, other notifications, etc. Subjects and concepts, in the context of a social graph, comprise nodes that represent any person, place, thing, or idea.

A social networking system can enable a user to enter and display information related to the user's interests, age/date of birth, location (e.g., longitude/latitude, country, region, city, etc.), education information, life stage, relationship status, name, a model of devices typically used, languages identified as ones the user is facile with, occupation, contact information, or other demographic or biographical information in the user's profile. Any such information can be represented, in various implementations, by a node or edge between nodes in the social graph. A social networking system can enable a user to upload or create pictures, videos, documents, songs, or other content items, and can enable a user to create and schedule events. Content items can be represented, in various implementations, by a node or edge between nodes in the social graph.

A social networking system can enable a user to perform uploads or create content items, interact with content items or other users, express an interest or opinion, or perform other actions. A social networking system can provide various means to interact with non-user objects within the social networking system. Actions can be represented, in various implementations, by a node or edge between nodes in the social graph. For example, a user can form or join groups, or become a fan of a page or entity within the social networking system. In addition, a user can create, download, view, upload, link to, tag, edit, or play a social networking system object. A user can interact with social networking system objects outside of the context of the social networking system. For example, an article on a news web site might have a “like” button that users can click. In each of these instances, the interaction between the user and the object can be represented by an edge in the social graph connecting the node of the user to the node of the object. As another example, a user can use location detection functionality (such as a GPS receiver on a mobile device) to “check in” to a particular location, and an edge can connect the user's node with the location's node in the social graph.

A social networking system can provide a variety of communication channels to users. For example, a social networking system can enable a user to email, instant message, or text/SMS message, one or more other users. It can enable a user to post a message to the user's wall or profile or another user's wall or profile. It can enable a user to post a message to a group or a fan page. It can enable a user to comment on an image, wall post or other content item created or uploaded by the user or another user. And it can allow users to interact (e.g., via their personalized avatar) with objects or other avatars in an artificial reality environment, etc. In some embodiments, a user can post a status message to the user's profile indicating a current event, state of mind, thought, feeling, activity, or any other present-time relevant communication. A social networking system can enable users to communicate both within, and external to, the social networking system. For example, a first user can send a second user a message within the social networking system, an email through the social networking system, an email external to but originating from the social networking system, an instant message within the social networking system, an instant message external to but originating from the social networking system, provide voice or video messaging between users, or provide an artificial reality environment were users can communicate and interact via avatars or other digital representations of themselves. Further, a first user can comment on the profile page of a second user, or can comment on objects associated with a second user, e.g., content items uploaded by the second user.

Social networking systems enable users to associate themselves and establish connections with other users of the social networking system. When two users (e.g., social graph nodes) explicitly establish a social connection in the social networking system, they become “friends” (or, “connections”) within the context of the social networking system. For example, a friend request from a “John Doe” to a “Jane Smith,” which is accepted by “Jane Smith,” is a social connection. The social connection can be an edge in the social graph. Being friends or being within a threshold number of friend edges on the social graph can allow users access to more information about each other than would otherwise be available to unconnected users. For example, being friends can allow a user to view another user's profile, to see another user's friends, or to view pictures of another user. Likewise, becoming friends within a social networking system can allow a user greater access to communicate with another user, e.g., by email (internal and external to the social networking system), instant message, text message, phone, or any other communicative interface. Being friends can allow a user access to view, comment on, download, endorse or otherwise interact with another user's uploaded content items. Establishing connections, accessing user information, communicating, and interacting within the context of the social networking system can be represented by an edge between the nodes representing two social networking system users.

In addition to explicitly establishing a connection in the social networking system, users with common characteristics can be considered connected (such as a soft or implicit connection) for the purposes of determining social context for use in determining the topic of communications. In some embodiments, users who belong to a common network are considered connected. For example, users who attend a common school, work for a common company, or belong to a common social networking system group can be considered connected. In some embodiments, users with common biographical characteristics are considered connected. For example, the geographic region users were born in or live in, the age of users, the gender of users and the relationship status of users can be used to determine whether users are connected. In some embodiments, users with common interests are considered connected. For example, users' movie preferences, music preferences, political views, religious views, or any other interest can be used to determine whether users are connected. In some embodiments, users who have taken a common action within the social networking system are considered connected. For example, users who endorse or recommend a common object, who comment on a common content item, or who RSVP to a common event can be considered connected. A social networking system can utilize a social graph to determine users who are connected with or are similar to a particular user in order to determine or evaluate the social context between the users. The social networking system can utilize such social context and common attributes to facilitate content distribution systems and content caching systems to predictably select content items for caching in cache appliances associated with specific social network accounts.

Embodiments of the disclosed technology may include or be implemented in conjunction with an artificial reality system. Artificial reality or extra reality (XR) is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof. Additional details on XR systems with which the disclosed technology can be used are provided in U.S. patent application Ser. No. 17/170,839, titled “INTEGRATING ARTIFICIAL REALITY AND OTHER COMPUTING DEVICES,” filed Feb. 8, 2021 and now issued as U.S. Pat. No. 11,402,964 on Aug. 2, 2022, which is herein incorporated by reference.

Those skilled in the art will appreciate that the components and blocks illustrated above may be altered in a variety of ways. For example, the order of the logic may be rearranged, substeps may be performed in parallel, illustrated logic may be omitted, other logic may be included, etc. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc. Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

The disclosed technology can include, for example, a method with the following step for rendering pass-through content for a detected screen by an artificial reality (XR) system, system that performs the following steps for rendering pass-through content for a detected screen by an artificial reality (XR) system, or computer-readable storage medium storing instructions that, when executed by a computing system, cause the computing system to perform the following steps for rendering pass-through content for a detected screen by an artificial reality (XR) system: capturing, using one or more image capturing devices associated with the XR system, visual data of real-world surroundings of the XR system, wherein the captured visual data includes a depiction of a screen; rendering, by the XR system, a passthrough visual display of the captured real-world surroundings of the XR system using the captured visual data, wherein content is rendered within the screen by performing at least one of: rendering visual data captured in a previous iteration of the cycle in response to detecting that the visual data captured in a current iteration of the cycle comprises a threshold amount of blank or distorted visual data; combining visual data captured over multiple iterations of the cycle by concatenating portions of the multiple frames or interpolating visual data using the multiple visual frames; or rendering a virtual screen within the detected screen using content streamed to the XR system by a computing system associated with the detected screen.

I/We claim:

1. A method for viewing an area in an artificial reality environment that is blocked from view from a user's current location, the method comprising:
identifying a location associated with a viewing direction;
selecting one or more image acquisition devices based on the location;
obtaining video from one or more image acquisition device; and
presenting a version of the video to the user utilizing a head-mounted display.

2. A method for controlling rendering of virtual objects based on lighting conditions, the method comprising:
generating a map of one or more physical light sources in a real-world environment,
the map including a position and brightness of each physical light source,
wherein at least one of the one or more physical light sources is a smart light, and
wherein generating the map includes obtaining the position and the brightness of the at least one of the one or more physical light sources from the smart light;
placing one or more virtual light sources, respectively corresponding to the one or more physical light sources, in an artificial reality environment based on the map, the artificial reality environment including one or more virtual objects; and
rendering the one or more virtual objects based on the placing of the one or more virtual light sources.

3. A method for dynamically animating an avatar with facial expressions using wearable sensor(s), the method comprising:
receiving, at a source XR system, tracked user data comprising at least user audio sensed via one or more microphones and user video sensed via one or more cameras, wherein the one or more cameras are positioned at a wearable device worn at a user's wrist;
rendering an avatar of the user based on the tracked user data, wherein,
one or more first models determine whether or not the user video captures the user's face,
one or more second models process the user audio to generate user sentiment,
when it is determined the user video does not capture the user's face, facial expressions of the avatar are rendered to correspond with the generated user sentiment, and
when it is determined the user video captures the user's face, facial expressions of the avatar are rendered to mimic the captured user's face; and
streaming, to a target system, the rendered avatar of the user, wherein the target system displays the rendered avatar.
